(19) United States
(12) Patent Application Publication
(10) Pub. No.: US 2005/0235259 A1
(43) Pub. Date: Oct. 20, 2005

(54) Designing a rule for automated computer process

(76) Inventor: Hermann Lueckhoff, Sunnyvale, CA (US)

Correspondence Address: FISH & RICHARDSON, P.C., PO BOX 1022, MINNEAPOLIS, MN, 55440-1022, US

(21) Appl. No.: 10/950,049

(22) Filed: Sep. 24, 2004

Related U.S. Application Data
(60) Provisional application No. 60/563,259, filed on Apr. 15, 2004.

(51) Int. Cl. G06F 9/44

(52) U.S. Cl. 717/113; 717/116

(57) ABSTRACT

A method used while designing a rule to be applied as part of an automated computer process includes making fact attributes available in a graphical user interface of a computer system for user selection, each of the fact attributes identifying a pre-selected class of stored fact information that the computer system has been previously programmed to be able to retrieve. The method includes receiving an input indicating that a user selects at least one of the fact attributes as a condition in a rule to be created, the input further indicating an action to be associated with the rule. The method includes creating the rule upon receiving the input.

### CROSS-REFERENCE TO RELATED APPLICATION

This application claims the benefit of U.S. Provisional Patent Application Ser. No. 60/563,259, filed on Apr. 15, 2004, the contents of which are incorporated by reference into this document.

### TECHNICAL FIELD

This description relates to designing a rule to be applied as part of an automated computer process.

### BACKGROUND

A computer system may execute rules as part of an automated computer process to determine measures that the system should take. A rule may have a condition and an action associated with it, and if the condition is met upon applying the rule, the computer system performs the action. The system may apply the rule to information that has been gathered or retrieved specifically for purposes of rule application. That is, when a system is triggered to evaluate a rule in the course of an automated computer process, the system may retrieve the relevant information, apply the rule thereto, and take any action dictated by the outcome of the rule. An example of such rule evaluation is automated processing of electronic messages, or emails, where the rule may determine whether the system should route the email to a specific person, send an automatic response, or delete the message. Accordingly, a rule may be designed to probe for the existence of one or more identifiable portions of information that are considered relevant in processing the message.

Existing solutions that apply a rule as part of an automated computer process may be associated with disadvantages. The procedure for designing and creating rules may not be user friendly. Moreover, such solutions may allow a user to create a rule to be applied to a specific category of retrievable information without the system providing a specific service or process for retrieving the information. Also, if there is a change in the information-retrieving capacity of such a system, the system may not be able to ensure that users can take the change into account when creating rules.

### SUMMARY

The invention relates to designing a rule to be applied as part of an automated computer process.

In a first aspect, a method comprises making fact attributes available in a graphical user interface of a computer system for user selection. Each of the fact attributes identifies a pre-selected class of stored fact information that the computer system has been previously programmed to be able to retrieve. An input is received, indicating that a user selects at least one of the fact attributes as a condition in a rule to be created. The input further indicates an action to be associated with the rule. The rule is created upon receiving the input.

In selected embodiments, each of the fact attributes is associated with meta information stored in the computer system, and the computer system can retrieve a portion of the stored fact information that is a member of the pre-selected class.

In a second aspect, a method comprises initiating, at a user's request, a rule modeling application program in a computer system that further includes an electronic message response management system. The method comprises presenting fact attributes for user selection in a graphical user interface of the rule modeling application program. Each of the fact attributes identifies a pre-selected class of stored fact information that the electronic message response management system can retrieve. An input is received, indicating that the user selects at least one of the fact attributes as a condition in a rule to be created. The input further indicates a value for the condition and an action to be associated with the rule. The rule is created upon receiving the input, wherein the action will subsequently be performed if, upon applying the rule, a portion of the pre-selected class of stored fact information retrieved by the electronic message response management system includes the value.

Advantages of the system and techniques described herein may include any or all of the following. Improving design of a rule; providing a simplified selection of a fact attribute for a rule; providing that a user can create a rule that is based on a fact attribute recognized in the system; providing rule creation that is based on fact attributes that a system knows how to retrieve; providing that changes in what information the system can retrieve are conveniently shared with a rule modeler that creates rules to be applied to the retrieved information; providing a simplified configuration of fact attributes that are available for rule design; and providing that rules can be defined in relation to any possible contextual data as long as there is one or more services in the system that can retrieve this data.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system in which can be designed a rule to be applied as part of an automated computer process;

FIG. 2 is a flow chart of a method that can be performed in the FIG. 1 system;

FIG. 3 is a block diagram of a computer system that uses a created rule in processing a received electronic message;

FIG. 4 is a block diagram of selected parts of the system shown in FIG. 3;

FIG. 5 is an example of a graphical user interface that the FIG. 3 system can generate for a user to design a rule that can be used in processing a received electronic message;

FIG. 6 is a flow chart of a method that can be performed in the FIG. 3 system; and

FIG. 7 is a block diagram of a general computer system.

Like reference numerals in the various drawings indicate like elements.

### DETAILED DESCRIPTION

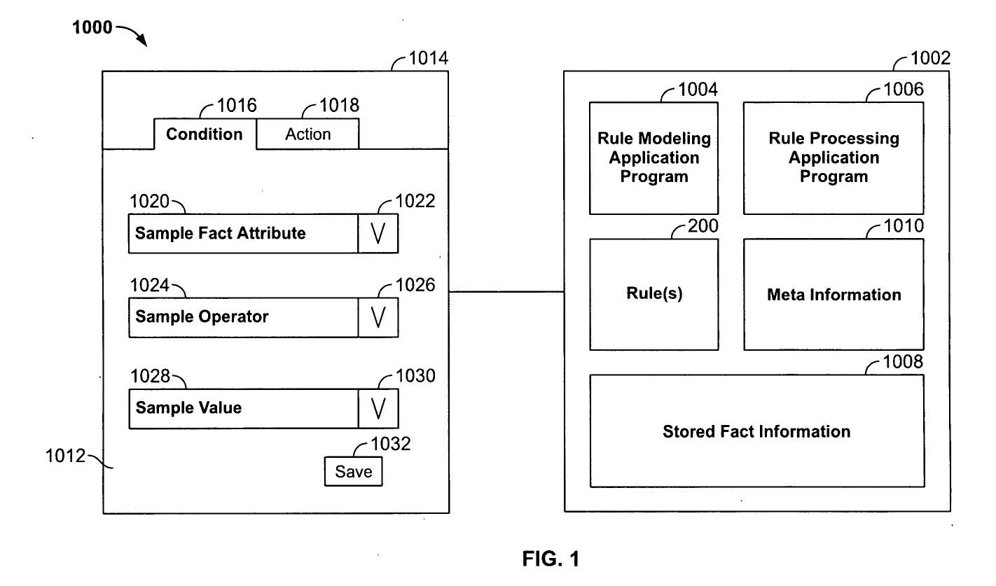

FIG. 1 is a block diagram of a system 1000 in which a user can design a rule to be applied as part of an automated computer process. The system includes a computer device 1002 that can create and apply the user-specified rule. That is, the user may design one or more rule(s) 200 using a rule modeling application program (RMAP) 1004. The system includes a rule processing application program (RPAP) 1006 that can retrieve information from stored fact information 1008 and apply the rule(s) in the course of an automated computer process. Particularly, knowledge about what information the RPAP is programmed to retrieve is available in the RMAP to the user designing the rule.

The RPAP 1006 may use meta information 1010 in retrieving the stored fact information 1008. Particularly, the meta information may identify a pre-selected class of the stored fact information that is to be retrieved. For example, the meta information may provide access to a service module that contains instructions for retrieving the information. Accordingly, the system 1000 is programmed with the RPAP to be able to retrieve this particular class or classes of stored fact information.

The stored fact information 1008 may be of many different kinds. The stored fact information may be generated in software applications or systems used by an organization that operates the system 1000. The following are selected examples of classes of stored fact information: analytical data, such as a customer rating or a chum rate; information pertaining to the organization's current workforce capacity, such as what employees are currently available and their respective skill(s); communication information such as correspondence information; information pertaining to an industry in which the operator of the system is active. Here, the stored fact information is located in the computer device 1002, but in other implementations it may be located in one or more other devices that the system 1000 can access.

The user can design a rule in the system 1000 by specifying a condition and an action for the rule, wherein the action will be performed if the condition is met upon applying the rule to the retrieved information. Particularly, a condition may have the following general format:
<Fact Attribute><Operator><Value>
   wherein <Fact Attribute> is an operand that acts as a placeholder for the retrieved information, <Value> is a pre-selected operand that is used in determining whether the rule is met based on the retrieved information, and <Operator> determines a relationship between the <Fact Attribute> and the <Value>. In one example, the <Operator> corresponds to “equals” and therefore determines whether <Fact Attribute> equals <Value>. Other operators may be used.

The RMAP 1004 can generate a graphical user interface (GUI) 1012 that can be presented on a display device 1014 connected to the computer device 1002. This exemplary GUI allows the user to select a condition tab 1016 for designing a condition for the rule, and an action tab 1018 for designing an action for the rule. Here, the condition tab is selected, and the GUI presents a fact attribute input field 1020 that makes fact attributes available for user selection, for example by activating a drop-down list box using a control 1022. Each of the fact attributes of the input field identifies a pre-selected class of the stored fact information 1008 that the system 1000 can retrieve using the RPAP 1006. Examples of fact attributes include a category, a score, an accuracy measurement, and combinations thereof. The user can enter one or more fact attributes in the input field to create the rule condition. The input field currently shows a “Sample Fact Attribute”.

The GUI 1012 may include an operator input field 1024 that makes operators available for user selection, for example by activating a drop-down list box using a control 1026. The user can enter one or more operators in the input field to create the rule condition. The input field currently shows a “Sample Operator”. Finally, the GUI 1012 may include a value input field 1028 that makes values available for user selection, for example by activating a drop-down list box using a control 1030. The user can enter one or more values in the input field to create the rule condition. The input field currently shows a “Sample Value”. Upon designing the condition and the action for the rule, the user may select a save button 1032 in the GUI 1012. This triggers an input of the entered information to the computer device 1002, which creates the rule upon receiving the input.

Thus, the RMAP creates a rule using fact attribute(s) that the RPAP can retrieve. One advantage of this implementation is that when the user is designing the rule, the user knows what information the system has previously been programmed to be able to retrieve. Another advantage is that when there is a change in the RPAP's information-retrieving capacity, a corresponding change can conveniently be made in the fact attributes available in the RMAP.

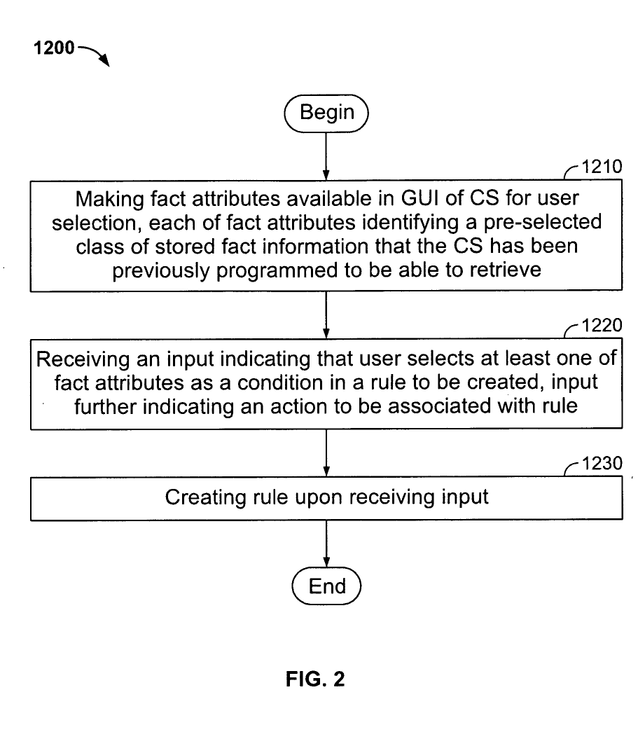

FIG. 2 is a flow chart of a method 1200 according to an embodiment of the invention. The method may be performed in the system 1000. For example, a computer program product can include instructions that cause a processor of the computer device 1002 to perform the steps of the method 1200. The method includes the following steps:

Making, in step 1210, fact attributes available in a GUI of a computer system for user selection, each of the fact attributes identifying a pre-selected class of stored fact information that the computer system has been previously programmed to be able to retrieve. For example, the system 1000 makes fact attributes available in the input field 1020, and each of the fact attributes identifies a pre-selected class of the stored fact information 1008. The RPAP 1006 can retrieve a portion of the stored fact information that is a member of the pre-selected class.

Receiving, in step 1220, an input indicating that a user selects at least one of the fact attributes as a condition in a rule to be created, the input further indicating an action to be associated with the rule. For example, the input can be generated upon the user selecting the save button 1032. The action, which comprises one or more measures to be taken if the condition is met upon applying the rule, can be specified under the action tab 1018. Alternatively, the system can specify the action, for example in a situation where the user is creating a condition for applying a standard action.

Creating, in step 1230, the rule upon receiving the input. For example, the system 1000 creates one of the rules 200 upon the user selecting the save button 1032.

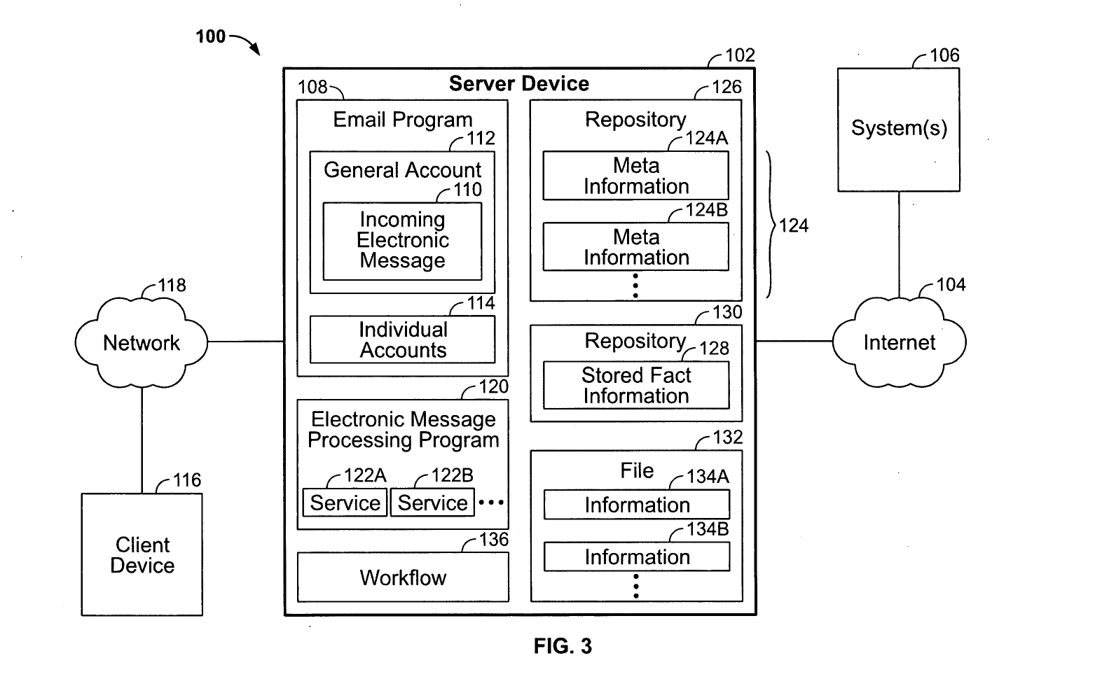

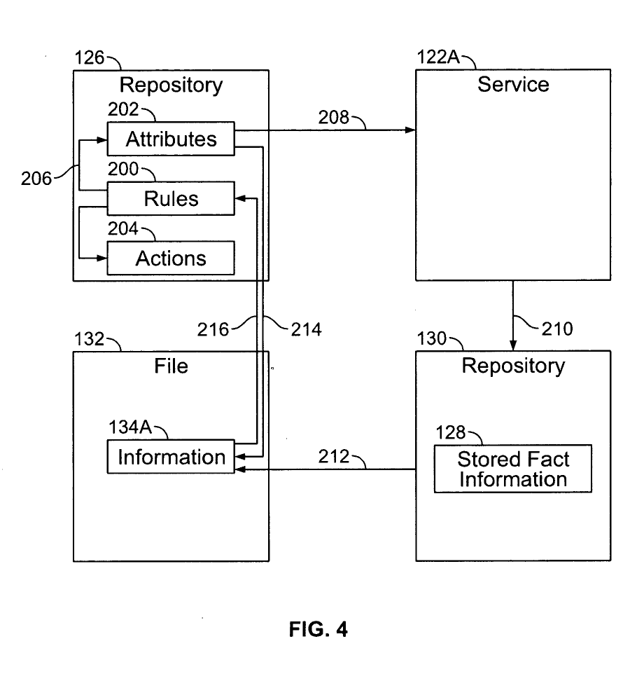

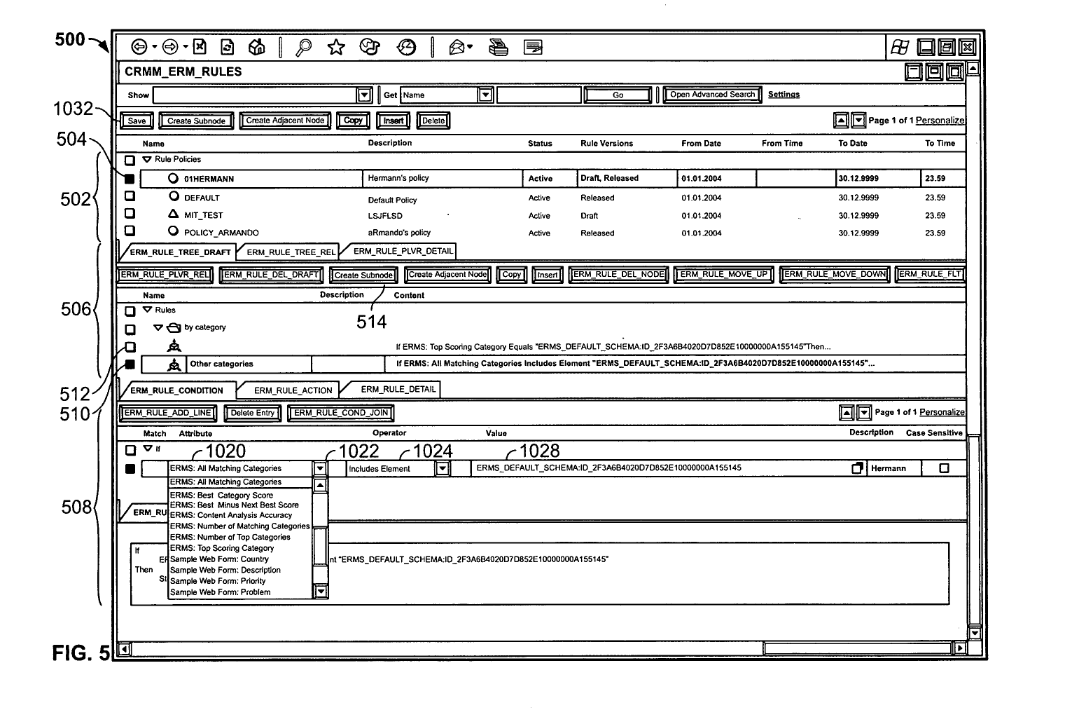

Rules created according to the above example can be applied as part of many different automated computer processes. For example, one or more rules can be applied in the context of receiving and processing electronic messages. It will therefore first be described, with reference to FIGS. 3 and 4, how a system can apply a user-designed rule to retrieved fact information as part of processing a received electronic message. Then it will be described, with reference to FIG. 5, how a user can design one or more rules using a GUI generated by the FIG. 3 system.

The description of FIGS. 3 and 4 is based on an exemplary scenario in which an organization receives a relatively large number of electronic messages in a more or less continuous flow and wishes to process the messages quickly and effectively. The messages may be received at a generic email address such as info@name_of_organization.com or equivalent. When a message is received, some or all of its contents are preferably automatically extracted and analyzed as a part of the processing. It may also be useful to retrieve information from other sources that relates to the message, because such information can be important in deciding what to do with the message. Based on the available information, one or more decisions on how to process the message will be made. For example, it may be decided to register the fact that the message was received and route it to an agent of the organization to handle the message. Preferably, the processing is done expediently so that there is no significant delay before the message is forwarded to its final recipient.

FIG. 3 shows a computer system 100 that can receive, process and route electronic messages. A server device 102 is operably connected to the Internet 104, through which it can receive emails and other electronic messages sent from one or more system(s) 106 that are also connected to the Internet. The server device 102 includes an email program 108 in which received messages, such as an exemplary incoming electronic message (IEM) 110, are accessible. The IEM 110 is currently shown in a general account 112 that for example corresponds to the generic email address mentioned above. The IEM 110 will be processed to determine what action(s), if any, the system should take in response to receiving it. For example, the processing may lead to the IEM 110 being routed to one or more individual accounts 114 in the email program 108. The individual accounts 114 are assigned to persons working within the organization, and these persons may access their respective individual account 114 using a client device 116 that is connected to the server device 102 through a network 118. For clarity of description in this example, only a single IEM 110 is shown in the general account 112 but in an actual implementation there may be many thousands of messages, or even hundreds of thousands or more.

The server device 102 includes an electronic message-processing program (EMPP) 120 that includes executable instructions for retrieving information that is relevant for deciding how to process the IEM 110. The EMPP 120 may include one or more services 122A, 122B, and so on, which are dedicated to the retrieval of specific portions of information. For example, the first service 122A includes executable instructions for retrieving a particular piece of fact information, the second service 122B includes executable instructions for retrieving another piece of fact information, and so on. Accordingly, the server device 102 is programmed with the EMPP to be able to retrieve the specified information.

Upon receiving the IEM 110, the server device 102 will access meta information 124 in a first repository 126. The meta information 124 specifies which portion(s) of stored fact information 128, located in a second repository 130, should be retrieved for processing the IEM 110. That is, the meta information 124 may identify which executable instruction in the EMPP 120 should be used.

The stored fact information 128 may include many separate classes of fact information, of which all, some, or only one is to be retrieved. There may therefore be separate portions of meta information 124, one for each class that is to be retrieved, so that the first repository 126 includes first meta information 124A, second meta information 124B, and so on. The first meta information 124A may identify the first service 122A, the second meta information 124B may identify the second service 122B, and so on. Several examples of what may constitute the respective classes of stored fact information 128 are will be described below.

The portion(s) of the stored fact information 128 that the server device retrieves will be stored in an electronic file 132 that is associated with the IEM 110. Accordingly, the electronic file 132 may include first retrieved portion 134A of stored fact information, second retrieved portion 134B of stored fact information, and so on. The retrieved portions in the file 132 will be accessed for applying one or more rules to them to determine what action(s) to take with regard to the IEM 110, as will be described below. It will be understood that the system 100 can include one separate electronic file 132 for each incoming message that is being processed.

The beginning, duration and end of the processing of IEM 110 may be controlled by a workflow 136. That is, the workflow 136 may contain the overarching instructions that the server device 102 follows upon receiving the IEM 110, including the initiation of fact retrieval. Accordingly, the workflow 136 for the IEM 110 may be active from a time when the IEM 110 is received until the processing is finished. Several separate instances of the workflow 136 may be active if more than one incoming message is being processed.

An example of fact retrieval, and process flows that may occur, will now be described with reference to FIG. 4, which includes some components of the system 100. Particularly, the first repository 126 includes rules 200, fact attributes 202 and actions 204, all of which are pre-selected to be used in processing the IEM 110, and the application of certain rules may be conditioned on the outcome of another rule. Upon receiving the IEM 110, the server device 102 may access the rules 200 sequentially to determine the facts needed to evaluate them.

Particularly, the rules 200 may be arranged in what can be thought of as a tree structure, where the outcome of applying the top rule to its particular fact(s), retrieved specifically with regard to the IEM 110, determines which rule to access in the second layer of rules in the tree structure, and so on. Thus, the server device 102 may work its way down in such a structure of rules until all applicable rules have been evaluated. This may lead to the retrieval of a certain amount of relevant fact information for the IEM 110. As an outcome of applying the rules to the retrieved information, one or more specific actions for processing the IEM 110 may then be performed.

Each of the rules 200 identifies one of the fact attributes 202 as being necessary for evaluating the rule, and the server device 102 will access the identified fact attribute to initiate the retrieval of the fact(s) to which the fact attribute corresponds. The fact attribute 202 identified by the specific rule 200 is an example of the meta information 124. The meta information 124 identifies a pre-selected class of stored fact information that is to be retrieved. Moreover, the first meta information 124A may correspond to a particular rule and to the fact attribute identified by it, the second meta information 124B may correspond to another rule and to the fact attribute identified by it, and so on. The step of accessing a specific attribute 202 is indicated by process flow arrow 206. The fact attribute corresponds to a specific class of the stored fact information 128. Particularly, the fact attribute in this example corresponds to a first class of stored fact information.

The first attribute 202 that is identified by the rule 200 includes an identifier that specifies where in the file 132 the retrieved information is to be stored. Later, when the information has been stored in file 132, the identifier may be used in accessing the information in the file.

The EMPP 120 contains instructions for retrieving the stored fact information. That is, the EMPP 120, or one or more of the services 122A, 122B, . . . , may be preconfigured with instructions for retrieving the necessary information for evaluating the particular rule. For example, the first service 122A may be preconfigured with instructions for the task of retrieving the stored fact(s) corresponding to the present fact attribute. The retrieval of the identified fact(s) is initiated as indicated by process flow arrow 208. The first service 122A, in turn, is configured with instructions for retrieving in the second repository 130 at least a portion of the stored fact information 128 that falls within the first class of stored fact information. The server device 102 therefore accesses, as indicated by process flow arrow 210, the stored fact information 128 in the second repository 130. The server device then stores the retrieved portion of fact information in the electronic file 132 as indicated by process flow arrow 212.

The retrieved information 134A will be accessed for purposes of applying the particular rule 200 to the retrieved information 134A. As indicated by process flow arrow 214, therefore, the server device 102 accesses in the file 132 the retrieved information 134A and, as indicated by process flow arrow 216, applies the rule 200 thereto. The server device may use the identifier included in the fact attribute 202 to access the retrieved information.

If the rule condition is met upon applying the rule to the retrieved information, the system performs the action that is associated with the rule. The following are some examples of rules and their associated actions.

### EXAMPLE 1

If a sender of the IEM 110 is from Canada, then the IEM is redirected to the individual account 114 that belongs to a Canadian representative of the organization. It may be possible to retrieve the information necessary for this rule from the IEM 110 itself by extracting the sender's email address or by identifying other country-specific information. Alternatively, if there have been previous contacts with the sender of the IEM 110, the organization may have a record of the sender from which the country of residence can be retrieved. The fact attribute here identifies one or more classes of stored fact information that include the knowledge necessary to determine the sender's country.

### EXAMPLE 2

A specific action is taken if the information that is retrieved for the IEM 110 shows that at least two previous messages with customer complaints have been received from the same sender. The specific action may be to set a high priority for handling the IEM 110 or routing it to the individual account 114 of a particular person within the organization. The fact attribute here identifies one or more classes of stored fact information that include messages previously received from the sender.

### EXAMPLE 3

A specific action is taken if the sender of the IEM 110 is a customer of the organization and if the churn rate for this customer is above a threshold level. For example, the organization has analytical software that is part of a customer-relationship management system, by which it can calculate a churn rate, i.e., a rate of customer attrition for an individual customer or collectively for all customers in a market sequent. One example of the specific action taken if the rule is met is sending an automatic confirmation message to the sender that the IEM 110 has been received. The fact attribute here identifies one or more classes of stored fact information that include the organization's customer records and customer churn rates.

### EXAMPLE 4

A response to the IEM 110 is automatically sent. The rule may be preconfigured such that it can be determined whether the nature of IEM 110 is such that an automatic response can be sent. Such an automatic response may be the only response provided to the IEM 110, or it may be a preliminary response. A basic example of when such an automatic response can be used is where the organization has set a deadline for receiving a message on a specific topic, such as responses to an outstanding offer. If the IEM 110 relates to this topic and is received after the deadline, a preconfigured response may be automatically sent. The fact attribute here identifies one or more classes of stored fact information that identify characteristics of messages to which the system should automatically send a response.

### EXAMPLE 5

A proposed response is compiled and forwarded to the organization employee who is charged with handling the IEM 110. Essentially, the person may receive in his or her individual account 114 the IEM 110 together with the proposed response, which includes preconfigured instructions for how to handle the IEM 110. For example, the organization may formulate instructions in advance that relate to a number of foreseeable situations regarding incoming electronic messages. The instructions may be tailored toward circumstances that involve who the sender is, the particular time when the IEM 110 is received, whether there have been complaints from the sender in the past, and the existence or absence of other specific business information in the system 100. The fact attribute here identifies one or more classes of stored fact information that include the knowledge that is relevant for determining whether to create a proposed response and what its contents should be.

### EXAMPLE 6

A rule can be formulated to detect unwanted mass-distributed messages (so-called “spam”) using any suitable technique. Conversely, if the IEM 110 is not deleted, one of the actions performed in response to receiving it may be to store information about it that can be used in processing future messages from the same or a related sender. Compare Example 2 above where previously received messages are taken into account. The fact attribute here identifies one or more classes of stored fact information that are relevant for deciding whether the IEM is an unwanted mass-distributed message.

Other types of rules, and other actions following them, can be used. Indeed, the first repository 126 can include meta information for a virtually endless range of classes of stored fact information. Some examples will be mentioned, with the understanding that certain categories of information may in part overlap, and that the mentioned classes are illustrative only.

Generally, the information to be retrieved may pertain to the business context of the IEM 110 from the organization's perspective. The scope of the business context may be defined in view of the particular activities that the organization is involved with. For example, the business context may comprise an email thread in the email program 108. As another example, the business content may comprise a process in the system 100 that relates to the IEM 110, such as a case, order, contract or another workflow used by the organization. In other words, the organization may decide what is the relevant business context of received messages and configure the server device to retrieve information within that context.

For clarity, the stored fact information 128 is shown in a single second repository 130. However, the server device 102 may be preconfigured with instructions for how to retrieve information from any location where it may find stored fact information identified by the meta information in the first repository. This may be done by including services 122A, 122B, and so on, which contain instructions for retrieving the respective facts.

FIG. 5 is an example of a GUI 500 that the system 100 or the system 1000 can generate and with which a user can design a rule to be applied as part of processing received electronic messages. The GUI includes a policy selection area 502 wherein the user can select a policy in which to include the rule to be created. A policy includes one or more rules and the system can include several policies that can be applied separately. Here, a first policy 504 has been selected.

Rules that are included in the selected policy are listed in a rule display area 506 below the area 502. For example, the policy may include a tree structure of rules that is shown in this area. A set of rules can be structured in several ways in the area 502. Here, the set of rules is structured “by category” in a folder.

In a rule creation area 508 below the area 506, the user can design one or more rules for the selected policy. For example, the area 508 includes a version of the fact attribute selection input field 1020 that makes fact attributes available for user selection. Here, the control 1022 has been activated and the input field currently displays several fact attributes in a list box. Here, the presented fact attributes include: categories (such as “All Matching Categories”); scores (such as “Best Minus Next Best Score”); and accuracy measurements (such as “Content Analysis Accuracy”). The user can select one or more of the available fact attributes as a condition for the rule to be created. If the user selects several fact attributes, the rule may join them by a logical operator such as a logical AND or a logical OR.

The rule creation area 508 also includes a version of the operator input field 1024 that makes operators available for user selection, and a version of the value input field 1028 where the user can enter one or more values for the rule. The operator currently selected in the field 1024 is “Includes Element” and the value in the field 1028 is “ERMS_DEFAULT_SCHEMA:ID_{—}2F3A6B4020D7D852E10000000A155145.” These exemplary settings mean that the rule condition is met if the retrieved portion of stored fact information includes the element ERMS_DEFAULT_SCHEMA:ID_{—}2F3A6B4020D7D852E10000000A155145. The user can select the save button 1032 to trigger an input that causes the system to create the rule as specified by the user. Here, the system creates a rule 510 and displays it in the rule display area 506. Another rule 512 that is displayed in this area includes the same value but has a different operator, namely “Equals”, and a different fact attribute, namely “Top Scoring Category”.

A control 514 allows the user to create a subrule to any existing rule. The system applies the subrule if the rule condition is met upon applying the rule. For example, the fact attribute of the rule 510 refers to all matching categories, which may be a broad group of categories that includes the top-scoring category referred to by the rule 512 fact attribute. The user may therefore choose to make the rule 512 a subrule of the rule 510. Thus, upon determining that the value is included at least somewhere among all matching categories (rule 510), the system thereafter probes whether there is a match (“equals”) in the top-scoring category (rule 512).

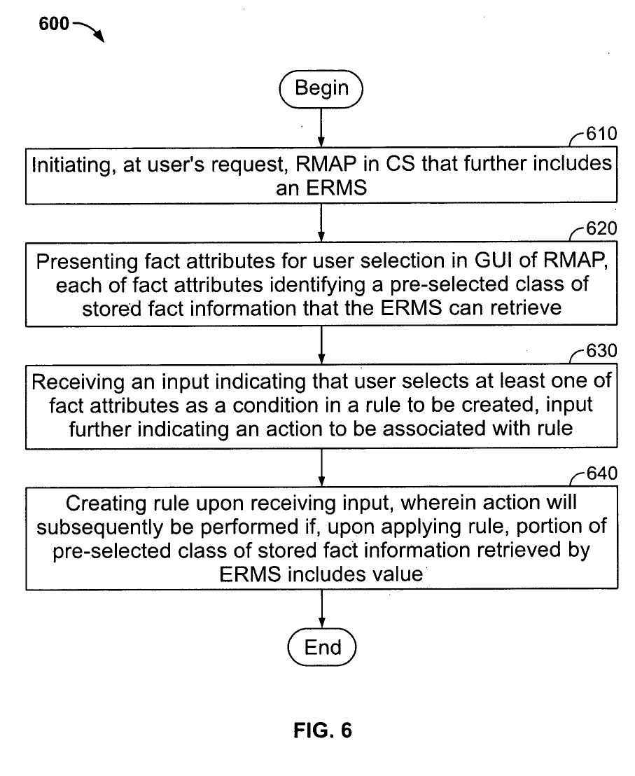

FIG. 6 is a flow chart of a method 600 according to another embodiment of the invention. For example, a computer program product can include instructions that cause a processor to perform the steps of the method 600. The method includes the following steps:

Initiating, in step 610 at a user's request, a rule modeling application program in a computer system that further includes an electronic message response management system. For example, the user can launch the RMAP 1004 in the system 1000, and the RPAP 1006 may comprise the EMPP 120 and other components for the email processing.

Presenting, in step 620, fact attributes for user selection in a graphical user interface of the rule modeling application program, each of the fact attributes identifying a pre-selected class of stored fact information that the electronic message response management system can retrieve. For example, the GUI 1012 can present fact attributes in the list box of the input field 1020. As another example, fact attributes can be presented in the GUI 500.

Receiving, in step 630, an input indicating that the user selects at least one of the fact attributes as a condition in a rule to be created, the input further indicating a value for the condition and an action to be associated with the rule. For example, the user may select the save button 1032 upon designing a rule in any of the GUIs 1012 and 500.

Creating, in step 640, the rule upon receiving the input, wherein the action will subsequently be performed if, upon applying the rule, a portion of the pre-selected class of stored fact information retrieved by the electronic message response management system includes the value. For example, the system 1000 may create one of the rules 200 upon the user selecting the save button 1032.

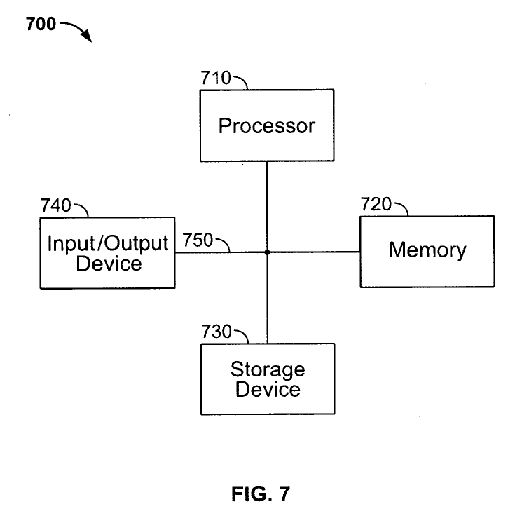

FIG. 7 is a block diagram of a general computer system 700 that can be used in the operations described above, according to one embodiment. The system 700 includes a processor 710, a memory 720, a storage device 730 and an input/output device 740. Each of the components 710, 720, 730 and 740 are interconnected using a system bus 750. For example, any or both of the computer system 1000 and the system 100 may include the components 710-750.

The processor 710 is capable of processing instructions for execution within the system 700. In one embodiment, the processor 710 is a single-threaded processor. In another embodiment, the processor 710 is a multi-threaded processor. The processor 710 is capable of processing instructions stored in the memory 720 or on the storage device 730, including for receiving or sending information through the input/output device 740.

The memory 720 stores information within the system 700. In one embodiment, the memory 720 is a computer-readable medium. In one embodiment, the memory 720 is a volatile memory unit. In another embodiment, the memory 720 is a non-volatile memory unit.

The storage device 730 is capable of providing mass storage for the system 700. In one embodiment, the storage device 730 is a computer-readable medium. In various different embodiments, the storage device 730 may be a floppy disk device, a hard disk device, an optical disk device, or a tape device.

The input/output device 740 provides input/output operations for the system 700. In one embodiment, the input/output device 740 includes a keyboard and/or pointing device. In one embodiment, the input/output device 740 includes a display unit for displaying graphical user interfaces. The input/output device 740 may display any or both of the GUIs 1012 and 500. The display device 1014 may include the input/output device 740.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method used while designing a rule to be applied as part of an automated computer process, the method comprising:
making fact attributes available in a graphical user interface of a computer system for user selection, each of the fact attributes identifying a pre-selected class of stored fact information that the computer system has been previously programmed to be able to retrieve;
receiving an input indicating that a user selects at least one of the fact attributes as a condition in a rule to be created, the input further indicating an action to be associated with the rule; and
creating the rule upon receiving the input.

2. The method of claim 1, wherein the condition further includes a value for the selected fact attribute and an operator for comparing the fact attribute with the value.

3. The method of claim 2, wherein the value and the operator are included in the input.

4. The method of claim 3, wherein the user selects the value and the operator among several alternatives.

5. The method of claim 1, wherein each of the fact attributes is associated with meta information stored in the computer system, and wherein the computer system can retrieve a portion of the stored fact information that is a member of the pre-selected class.

6. The method of claim 5, wherein an electronic message response management system in the computer system retrieves the portion of the stored fact information.

7. The method of claim 1, wherein the at least one of the fact attributes is selected from the group consisting of: a category, a score, an accuracy measurement, and combinations thereof.

8. The method of claim 1, wherein the input includes more than one of the fact attributes as the condition for the rule.

9. The method of claim 8, wherein the condition comprises the more than one of the fact attributes are joined by a logical operator.

10. The method of claim 1, further comprising receiving a second user input to create a subrule to the rule, wherein the computer system applies the subrule if the condition of the rule is met upon applying the rule.

11. The method of claim 1, further comprising creating a policy that includes the created rule and at least one other rule.

12. The method of claim 1, wherein the pre-selected class of stored fact information pertains to at least one category selected from the group consisting of: a business context, analytical data, availability of a person, a skill of a person, communication information, industry information, and combinations thereof.

13. A computer program product containing executable instructions that when executed cause a processor to perform operations comprising:
make fact attributes available in a graphical user interface of a computer system for user selection, each of the fact attributes identifying a pre-selected class of stored fact information that the computer system has been previously programmed to be able to retrieve;
receive an input indicating that a user selects at least one of the fact attributes as a condition in a rule to be created, the input further indicating an action to be associated with the rule; and
create the rule upon receiving the input.

14. A method for use in a computer system for responding to received electronic messages, the method comprising:
initiating, at a user's request, a rule modeling application program in a computer system that further includes an electronic message response management system;
presenting fact attributes for user selection in a graphical user interface of the rule modeling application program, each of the fact attributes identifying a pre-selected class of stored fact information that the electronic message response management system can retrieve;
receiving an input indicating that the user selects at least one of the fact attributes as a condition in a rule to be created, the input further indicating a value for the condition and an action to be associated with the rule; and
creating the rule upon receiving the input, wherein the action will subsequently be performed if, upon applying the rule, a portion of the pre-selected class of stored fact information retrieved by the electronic message response management system includes the value.

15. The method of claim 14, further comprising receiving an incoming electronic message and using the rule to process the incoming electronic message.

16. The method of claim 14, wherein the computer system has stored therein meta information that is associated with the at least one of the fact attributes, further comprising using the meta information to retrieve the portion of the stored fact information that is a member of the pre-selected class.

17. The method of claim 16, further comprising storing the retrieved portion of the stored fact information in an electronic file that is associated with the incoming electronic message.

18. The method of claim 17, further comprising applying the rule to the retrieved portion of the stored fact information in the electronic file and performing the action if the portion includes the value.

19. The method of claim 14, wherein the retrieved portion of the stored fact information pertains to at least one category selected from the group consisting of: a business context of the incoming electronic message, analytical data relating to the incoming electronic message, availability of a person for attending to the incoming electronic message, a skill of a person for attending to the incoming electronic message, communication information relating to the incoming electronic message, an industry with which the incoming electronic message is associated, and combinations thereof.

20. A computer program product containing executable instructions that when executed cause a processor to perform operations comprising:
initiate, at a user's request, a rule modeling application program in a computer system that further includes an electronic message response management system;
present fact attributes for user selection in a graphical user interface of the rule modeling application program, each of the fact attributes identifying a pre-selected class of stored fact information that the electronic message response management system can retrieve;
receive an input indicating that the user selects at least one of the fact attributes as a condition in a rule to be created, the input further indicating a value for the condition and an action to be associated with the rule; and
create the rule upon receiving the input, wherein the action will subsequently be performed if, upon applying the rule, a portion of the pre-selected class of stored fact information retrieved by the electronic message response management system includes the value.
